(19) United States
(12) Patent Application Publication
(10) Pub. No.: US 2007/0025128 A1
(43) Pub. Date: Feb. 1, 2007

(54) Power supplying apparatus and electronic device using the same

(75) Inventor: Jae-deok Cha, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/486,290

(22) Filed: Jul. 14, 2006

(30) Foreign Application Priority Data
Jul. 27, 2005 (KR) 2005-68575

(51) Int. Cl. H02M 7/00

(52) U.S. Cl. 363/125

(57) ABSTRACT

A power supplying apparatus to supply DC power for driving an electronic device, and an electronic device using the same that includes an AC/DC converter which converts input AC power into the DC power; and an AC switch which switches the AC power input to the AC/DC converter, based on a switching signal supplied from the electronic device. Thus, the power supplying apparatus receives information on an operation state of the electronic device from the electronic device to control an input of AC (alternating current) power according to the operation state of the electronic device.

### CROSS-REFERENCE TO RELATED APPLICATION

This application claims the benefit of Korean Patent Application No. 2005-68575, filed on Jul. 27, 2005 in the Korean Intellectual Property Office, the disclosure of which is incorporated herein by reference.

### BACKGROUND OF THE INVENTION

1. Field of the Invention

Aspects of the present invention relate to a power supplying apparatus and an electronic device using the same, and more particularly, a power supplying apparatus which controls AC (alternating current) power supplied to an adaptor according to whether power is output to an electronic device, and an electronic device using the same.

2. Description of the Related Art

Electronic devices which employ batteries are being widely used as they can be portable and used even while being mobile. The electronic devices comprise portable computers such as a laptop computer, a notebook computer, a PDA (personal digital assistant), mobile phones, CD players and video camcorders, etc. Also, the electronic devices have an adaptor connection terminal therein to use an adaptor which converts commercial AC (alternating current) power into DC (direct current) power.

The portable electronic devices may use batteries while being carried, instead of the adaptor. A secondary battery may be used as the battery of the electronic devices to be charged through power from the adaptor connected to the electronic devices.

FIG. 1 is a configuration of a conventional adaptor 100. As shown therein, the adaptor 100 has a rectifying circuit 120 to rectify input AC power 110; a smoother 130 such as a capacitor which makes the power rectified by the rectifying circuit 120 smooth; and a DC/DC converter 140 to convert the power smoothed by the smoother 130 into DC power at a predetermined level output to the electronic device (not shown) and to output it.

As shown, the rectifying circuit 120 is provided as a full bridge type diode rectifying circuit. The DC/DC converter 140 is provided as a flyback DC/DC converter. The flyback DC/DC converter is driven by an operation of a transistor through a pulse-width modulation (PWM) method. However, if the AC power 110 is input, the conventional adaptor 100 operates to allow the DC/DC converter 140 to output the DC power, regardless of an operation state of the electronic apparatus. Thus, even if the electronic device is not in operation and/or does not use the DC power, there occur line losses and switching losses in the DC/DC converter 140.

Further, as the rectifying circuit 120, the smoother 130 and the DC/DC converter 140 operate regardless of a drive (or an operation) of the electronic device, the DC power output from the rectifying circuit 120 is continuously supplied to the smoother 130 and a lifespan of the capacitor included in the smoother 130 may be reduced.

### SUMMARY OF THE INVENTION

Accordingly, aspects of the present invention include a power supplying apparatus which receives information on an operation state of an electronic device from an electronic device to control an input of AC (alternating current) power according to the operation state of the electronic device, and an electronic device using the same.

Additional aspects and/or advantages of the present invention will be set forth in part in the description which follows and, in part, will be obvious from the description, or may be learned by practice of the present invention.

The foregoing and/or other aspects of the present invention include a power supplying apparatus to supply DC power to drive an electronic device, including an AC/DC converter which converts input AC power into the DC power; and an AC switch which switches the AC power input to the AC/DC converter, based on a switching signal supplied from the electronic device.

According to another aspect of the present invention, the switching signal supplied from the electronic device comprises a first switching signal and a second switching signal, and the AC switch comprises a first relay part which is magnetized by the AC power to input the AC power to the AC/DC converter; a first switching element which is turned on corresponding to the first switching signal to make the first relay part magnetized by the AC power; a second relay part which is magnetized by the DC power to cut off the first relay part from being magnetized by the AC power; and a second switching element which is turned on corresponding to the second switching signal to make the second relay part magnetized by the DC power.

According to another aspect of the present invention, the first relay part comprises a first A contact point to make the AC power input to the AC/DC converter according to a magnetization by the AC power and a second A contact point which is connected with the first switching element in parallel to maintain a magnetization state of the first relay part by the AC power according to the magnetization by the AC power.

According to another aspect of the present invention, at least one of the first switching signal and the second switching signal is supplied by the electronic device according to at least one of an operation state of the electronic device and a charge state of a battery provided in the electronic device.

The foregoing and/or other aspects of the present invention are also achieved by an electronic device including a system which has a plurality of electronic components therein, further including a power supplying apparatus which converts input AC power into DC power; and a power controller which controls the converting of the AC power input into the DC power by the power supplying apparatus according to the operation state of the system.

According to another aspect of the present invention, the power supplying apparatus comprises an AC/DC converter to convert the input AC power into the DC power, and an AC switch to control the AC power input to the AC/DC converter according to a control of the power controller.

According to another aspect of the present invention, the electronic device further comprises a battery to supply power to the system, wherein the power controller outputs one of a first switching signal and a second switching signal to the power supplying apparatus based on at least one of the operation state of the system and a charge state of the battery by the DC power from the power supplying apparatus, and the AC switch comprises a first relay part which is magnetized by the AC power to input the AC power to the AC/DC converter; a first switching element which is turned on corresponding to the first switching signal to make the first relay part magnetized by the AC power; a second relay part which is magnetized by the DC power to cut off the first relay part from being magnetized by the AC power; and a second switching element which is turned on corresponding to the second switching signal to make the second relay part magnetized by the DC power.

According to another aspect of the present invention, the first relay part comprises a first A contact point to make the AC power input to the AC/DC converter according to a magnetization by the AC power and a second A contact point which is connected with the first switching element in parallel to maintain a magnetization state of the first relay part by the AC power according to the magnetization by the AC power.

According to another aspect of the present invention, the power controller outputs the second switching signal to the power supplying apparatus if it detects that the charge of the battery is completed in a state that the system does not operate.

According to another aspect of the present invention, the power controller outputs the first switching signal to the power supplying apparatus if it detects an operation of the system or a charge attempt of the battery.

According to another aspect of the present invention, the electronic device further comprises a power button to turn on the electronic device and an auxiliary power source to supply power to the power button, wherein the first switching signal is output to the power supplying apparatus corresponding to an adjustment of the power button.

According to another aspect of the present invention, An apparatus to supply DC power to an electronic device includes a converter to convert AC power into DC power, a switch that enables the converter to convert AC power into DC power based on a first signal from the electronic device, and disables the converter from converting AC power into DC power based on a second signal from the electronic device.

### BRIEF DESCRIPTION OF THE DRAWINGS

The above and/or other aspects and advantages of the present invention will become apparent and more readily appreciated from the following description of the aspects, taken in conjunction with the accompanying drawings of which:

FIG. 1 is a control block diagram of a conventional adaptor;

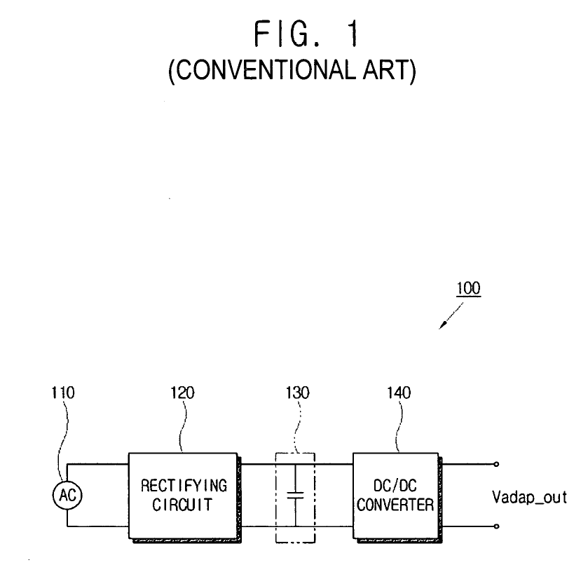

FIG. 2 is a control block diagram of a power supplying apparatus according to an aspect of the present invention;

FIG. 3 illustrates a detailed power supplying apparatus of FIG. 2;

FIG. 4 is a control block diagram of an electronic device according to an aspect of the present invention; and

FIG. 5 illustrates an example of a power controller of the electronic device of FIG. 4.

### DETAILED DESCRIPTION OF THE INVENTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Here, a power supplying apparatus is shown in the form of an adaptor as an example of the present invention. The power supplying apparatus according to an aspect of the present invention includes a device which converts input AC power into DC power to supply it to an electronic device, regardless of its type or use. Also, the adaptor according to the present invention may be externally provided to be connected to a DC power jack of the electronic device, or mounted in, or integrated with the electronic device.

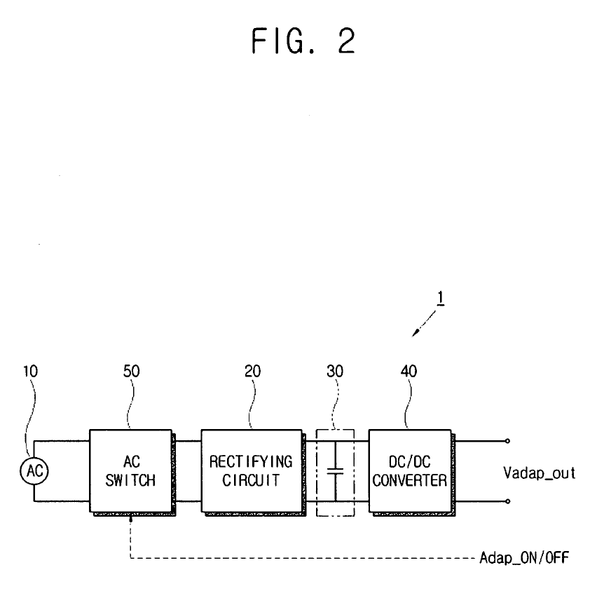

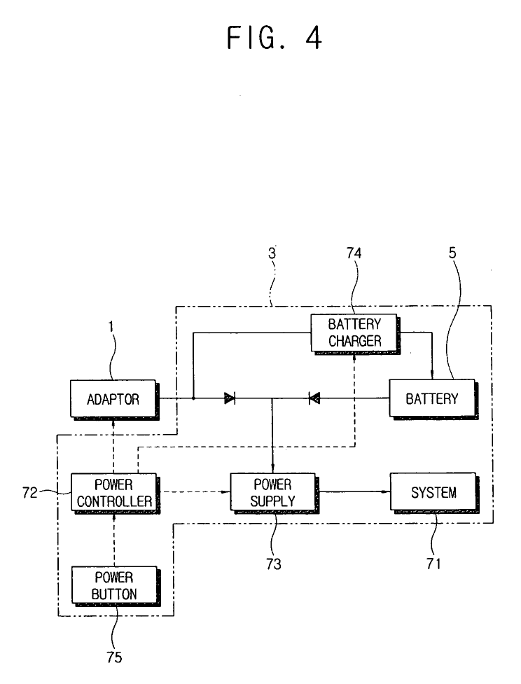

As shown in FIG. 2, an adaptor 1 according to an aspect of the present invention comprises AC/DC converter and an AC switch 50. The AC/DC converter comprise a rectifying circuit 20 which rectifies input AC power 10; a smoother 30 (such as a capacitor) which makes power rectified by the rectifying circuit 20 smooth; a DC/DC converter 40 which converts power smoothed by the smoother 30 into DC power (hereinafter, to be referred to as adaptor DC power ‘Vadapt_out’) at a predetermined level output Vadapt-out to an electronic device 3 (shown in FIG. 4, and to be discussed below), and outputs it.

As shown, the rectifying circuit 20 employs a full bridge type diode rectifying circuit. The DC/DC converter 40 is provided as a flyback DC/DC converter. The flyback DC/DC converter is driven by an operation of a transistor through a PWM method. However, other types of circuits, converters, and smoothers can be used.

The AC switch 50 controls the AC power 10 which is input to the AC/DC converter for conversion into DC power according to a switching signal supplied from a power controller 72 (to be described below). While not required in all aspects, the switching signal comprises a first switching signal Adapt_ON and a second switching signal Adapt_OFF (to be described below).

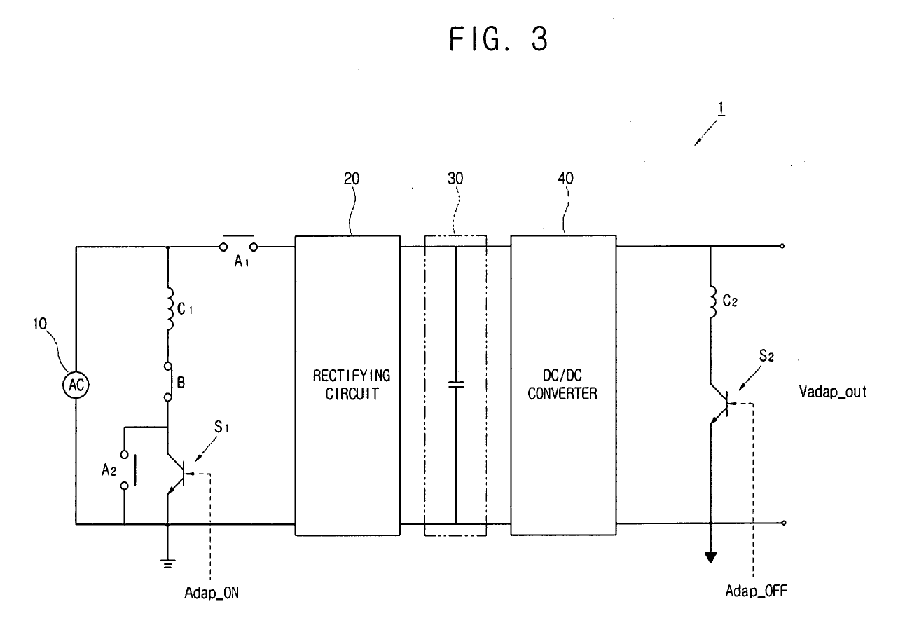

Hereinafter, the AC switch 50 according to an aspect of the present invention will be described in detail with reference to FIG. 3. In the aspect of the present invention as shown in FIG. 3, the AC switch 50 comprises a first relay part, a second relay part, a first switching element S1 and a second switching element S2. It is understood that a single relay part and/or switch can be used in other aspects of the present invention.

The first relay part controls the AC power 10 to be supplied to the AC/DC converter. Here, the first relay part is magnetized by the AC power 10 input to the adaptor 1 to be switched on and off. In the aspect of the present invention as shown in FIG. 3, the first relay part comprises a first coil C1, which is magnetized by the AC power 10; and a first A contact point A1 to allow the AC power 10 to be input to the AC/DC converter according to a magnetization of the first coil C1. As shown, the first coil C1 is provided on a line which is connected with the rectifying circuit 20 in parallel. The first A contact point A1 is provided on a supplying line of the AC power 10 between the rectifying circuit 20 and the first coil C1.

The first switching element S1 is connected with the first coil C1 in series and is turned on and off by the first switching signal Adapt_ON supplied from the power controller 72. If the first switching element S1 is turned on by the first switching signal Adapt_ON, the first coil C1 is magnetized by the AC power 10, and the first A contact point A1 is turned on corresponding to the magnetization of the first coil C1.

In the aspect of the present invention shown, the first relay part further comprises a second A contact point A2. The second A contact point A2 is connected with the first switching element S1 in parallel to be turned on corresponding to the magnetization of the first coil C1 by the AC power 10. If the second A contact point A2 is turned on corresponding to the magnetization of the first coil C1, the first coil C1 remains magnetized by the AC power 10. That is, even if the first switching element S1 does not remain the turned-on state, the first coil C1 may remain magnetized by a turning on of the second A contact point A2. Thus, the first switching signal Adapt_ON from the power controller 72 need not be maintained continuously in the turned-on state. The first switching signal Adapt_ON from the power controller 72 may be applied with a pulse signal. However, when the Adapt_ON signal is continuously applied, it is understood that the second A contact point A2 is not required.

Meanwhile, in the aspect of the present invention, the second relay part comprises a second coil C2. The second coil C2 is connected to an output terminal of the DC/DC converter 40 in parallel to be magnetized by adaptor DC power Vadapt_out output from the DC/DC converter 40. The second relay point further includes a B contact point “B”, which is connected to the first switching element S1 and the first coil C1 in series to be turned off corresponding to a magnetization of the second coil C2.

The second switching element S2 is connected to the second coil C2 in series, and turned on and off by the second switching signal Adapt_OFF from the power controller 72 to determine whether to magnetize the second coil C2. That is, if the second switching element S2 is turned on by the second switching signal Adapt_OFF, the second coil C2 is magnetized by the DC power output from the DC/DC converter 40.

When the B contact point “B” is turned off corresponding to the magnetization of the second coil C2, and the magnetization of the first coil C1 of the first relay part is released corresponding to the turned-off state of the B contact point “B”, the first A contact point A1 and the second contact point A2 of the first relay part are turned off to cut off the AC power 10 supplied to the rectifying circuit 20.

With the foregoing configuration, the process of turning on and off the adaptor 1 according to an aspect of the present invention will be described as follows. When the adaptor 1 is turned off (i.e., when the AC power 10 is not input to the AC/DC converter), the first A contact point A1 and the second A contact point A2 of the first relay part are turned off, and the B contact point “B” of the second relay part remains in the turned-on state.

If the first switching signal Adapt_ON is supplied from the power controller 72, the first switching element S1 is turned on. As the first switching element S1 is turned on, the fist coil C1 is magnetized by the AC power 10 to turn on the first A contact point A1, the second A contact point A2 and B contact point B. Then, the AC power 10 is input to the AC/DC converter and the adaptor 1 may output the adaptor DC power Vadapt_out. Here, even if the first switching signal Adapt_ON is applied with a pulse signal, the first coil C1 may remain magnetized corresponding to the turning-on of the second A contact point A2.

When the second switching signal Adapt_OFF is supplied from the power controller 72 in a state that the adaptor 1 is capable of outputting the DC power (i.e., in a state that the first A contact point A1 and the second A contact pint A2 are turned on), the second switching element S2 is turned on. As the second switching element S2 is turned on, the second coil C2 is magnetized by the adaptor DC power Vadapt_out output from the DC/DC converter 40. At this time, the B contact point “B” is turned off corresponding to the magnetization of the second coil C2 to release the magnetization of the first coil C1.

Accordingly, as the magnetization of the first coil C1 is released, the first A contact point A1 and the second A contact point A2 are turned off to cut off the AC power 10 input to the AC/DC converter. As the AC power 10 input to the AC/DC converter is cut off, the adaptor DC power Vadapt_out output from the DC/DC converter 40 is cut off. Then, the magnetization of the second coil C2 is released to turn on the B contact point “B”. The first coil C1 may be magnetized by the subsequent first switching signal Adapt_ON.

Hereinafter, the electronic device 3 using the adaptor 1 will be described with reference to FIG. 4. While not required in all aspects, the electronic device can be a non-rechargeable battery or a fuel cell. If so, the battery charger 74 is not required.

In the aspect of the present invention as shown in FIG. 4, the electronic device 3 according to the present invention may be driven by power supplied from one of the adaptor 1, the battery 5, or any combination thereof. Here, power supplied from the adaptor 1 will be referred to as the adaptor DC power Vadapt_out. Power supplied from the battery 5 will be referred to as battery DC power.

As shown in FIG. 4, the electronic device 3 according to the aspect of the present invention includes a system 71, a power supply 73 and a power controller 72. The electronic device 3 also includes a battery charger 74 and a power button 75, which may not be required in other aspects of the present invention. The system 71 comprises a plurality of electronic components to perform main functions of the electronic device 3 when it receives system driving power from the power supply 73. For example, if the electronic device 3 according to the present invention is provided as a portable computer, the electronic components of the system 71 may comprise a CPU, a memory such as a RAM, a chipset, a main board, a graphic card, etc. It is understood that any electronic device capable of being supplied with DC power is within the scope of the invention, such as portable video games, etc.

The power supply 73 converts the adaptor DC power Vadapt_out or the battery DC power supplied from the adaptor 1 or the battery 5, respectively, into the system driving powers of voltage levels required for driving the respective electronic components of the system 71, and outputs it. Here, the system 71 may comprise a plurality of voltage regulators which generate power of a predetermined voltage level according to the specification thereof. For example, if the electronic device 3 according to the present invention is provided as a portable computer, the respective voltage regulators of the power supply 73 output voltages at various levels such as 12V, 5V, 3.3V and 2.5V required to drive the respective electronic components of the system 71. The powers of various voltage levels output from the respective voltage regulators are used to drive the electronic components and/or to transmit signals as necessary. Moreover, while shown as using a rechargeable battery 5, the battery 5 can be replaced or supplemented with a non-rechargeable battery or a fuel cell, thus reducing or eliminating the need for a battery charger.

Meanwhile, the electronic device 3 according to an aspect of the present invention may comprise a battery charger 74 which uses the adaptor DC power Vadapt_out from the adaptor 1 to charge the battery 5. Here, the battery charger 74 charges the battery 5 according to a control of the power controller 72 and provides the power controller 72 with a signal to inform whether the charge (or charging) of the battery is completed.

The power controller 72 according to an aspect of the present invention manages power supplied from the power supply 73 to the system 71. Here, the power controller 72 controls the power supply 73 to supply the system driving power to the system 71, if it receives a turn-on (or adjustment) signal from a power button 75 to turn on the electronic device 3. If the electronic device 3 is turned off, or is forcibly turned off by the power button 75, the power controller 72 cuts off the system driving power supplied from the power supply 73 to the system 71.

Also, the power controller 72 according to the present invention outputs one of the first switching signal Adapt_ON and the second switching signal Adapt_OFF to the adaptor 1 based on the operation state of the system and the charge state of the battery 5 by the adaptor DC power Vadapt_out.

That is, if the operation of the system 71 or the charge (or the charge attempt) of the battery 5 by the adaptor DC power Vadapt_out is detected while the adaptor 1 is in an off state as described above, the power controller 72 outputs the first switching signal Adapt_ON to the adaptor 1. At this time, the operation process of the adaptor 1 according to the first switching signal Adapt_ON is as described above. Thus, the adaptor DC power Vadapt_out is supplied from the adaptor 1 to the power supply 73 to allow operation of the system 71, and/or to the battery charger 74 to charge the battery 5.

Here, the power controller 72 may detect the operation of the system 71 through the turn-on (or the adjustment) signal input from the power button 75. Accordingly, if a user adjusts (or switches) the power button 75 to turn on the electronic device 3 when the electronic device 3 is in the turned-off state (assuming the charge of the battery 5 is completed), the first switching signal Adapt_ON is supplied from the power controller 72 to the adaptor 1 to turn on the adaptor 1, corresponding to the turn-on signal of the power button 75.

If it is required to charge the battery 5 when the electronic device 3 is turned off, the power controller 72 supplies the first switching signal Adapt_ON to the adaptor 1 to turn on the adaptor 1, and controls the battery charger 74 to charge the battery 5 according to the adaptor DC power Vadapt_out from the adaptor 1.

When the power controller 72 detects that the system 71 does not operate and the charge of the battery 5 is completed, it outputs the second switching signal Adapt_OFF to the adaptor 1. That is, the power controller 72 outputs the second switching signal Adapt_OFF to the adaptor 1 to turn off the adaptor 1 if the electronic device 3 does not use the adaptor DC power Vadapt_out from the adaptor 1.

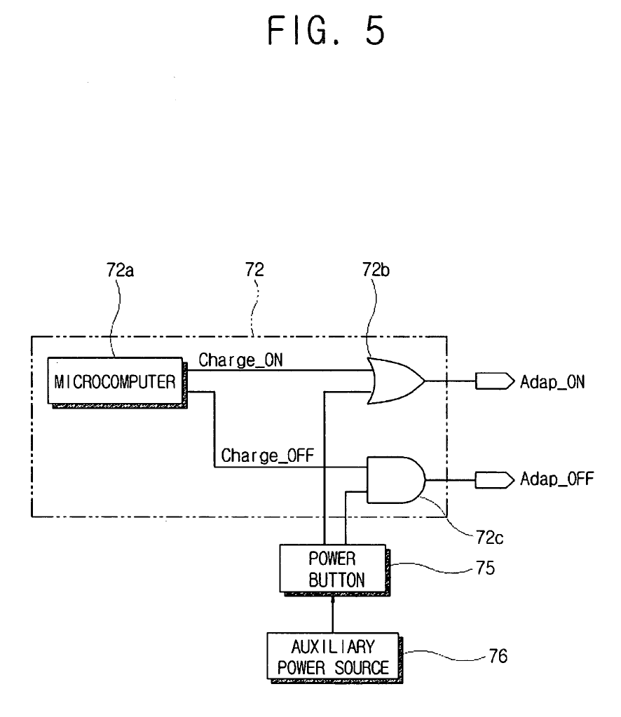

FIG. 5 illustrates an example of the power controller 72 according to an aspect of the present invention. As shown therein, the power controller 72 comprises a microcomputer 72a, an AND gate 72c, and an OR gate 72b. The microcomputer 72a controls the power supply 73 to supply or cut off power with respect to the system 71. Also, the microcomputer 72a outputs to the battery charger 74, a battery charge signal Charge_ON to make the battery charger 74 charge the battery 5, and a battery charge completion signal Charge_OFF to make the battery charger 74 complete (or end) the charge of the battery 5.

The OR gate 72b logically sums the battery charge signal Charge_ON output from the microcomputer 72a and the turn-on signal output from the power button 75 to turn on the electronic device 3, to output the first switching signal Adapt_ON.

The AND gate 72c logically multiplies the battery charge completion signal Charge_OFF output from the microcomputer 72a and a turn-off signal output from the power button 75 to turn off the electronic device 3, to output the second switching signal Adapt_OFF.

Preferably, and while not required in all aspects, the power button 75 receives power from an auxiliary power source 76, e.g., from an RTC battery mounted in a certain electronic component of the electronic device 3 to continuously supply power, regardless and/or independent of power from the adaptor 1 or the battery 5. Accordingly, even if the battery 5 is removed from the electronic device 3 in an off state of the adaptor 1, a user may adjust the power button 75 to turn on the adaptor 1 by an output of the turn-on signal from the power button 75.

In the foregoing aspects, the power controller 72 comprises the microcomputer 72a, the OR gate 72b and the AND gate 72c. Further, the power controller 72 may output the first switching signal Adapt_ON and the second switching signal Adapt_OFF to the adaptor 1 corresponding to the operation state of the system 71 and the charge state of the battery 5. It is preferable but not necessary that the first switching signal Adapt_ON is output to the adaptor 1 by an adjustment of the power button 75. Then, when the battery 5 is removed from the electronic device 3 and the adaptor 1 is in an off state, the adaptor 1 can be turned on by the adjustment of the power button 75 to turn on the electronic device 3.

Although a few aspects of the present invention have been shown and described, it will be appreciated by those skilled in the art that changes may be made in these aspects without departing from the principles and spirit of the invention, the scope of which is defined in the appended claims and their equivalents.

What is claimed is:

1. A power supplying apparatus to supply DC power to drive an electronic device, comprising:
an AC/DC converter which converts input AC power into the DC power; and
an AC switch which connects the AC power input to the AC/DC converter, based on a switching signal supplied from the electronic device, to selectively prevent conversion of the input AC power into the DC power.

2. The power supplying apparatus according to claim 1, wherein
the switching signal supplied from the electronic device comprises a first switching signal and a second switching signal, and
the AC switch comprises a first relay part which is magnetized by the AC power to input the AC power to the AC/DC converter; a first switching element which is turned on corresponding to the first switching signal to make the first relay part be magnetized by the AC power; a second relay part which is magnetized by the DC power to cut off the first relay part from being magnetized by the AC power; and a second switching element which is turned on corresponding to the second switching signal to make the second relay part be magnetized by the DC power.

3. The power supplying apparatus according to claim 2, wherein the first relay part comprises a first A contact point to make the AC power be input to the AC/DC converter according to a magnetization by the AC power and a second A contact point which is connected with the first switching element in parallel to maintain a magnetization state of the first relay part by the AC power according to the magnetization by the AC power.

4. The power supplying apparatus according to claim 3, wherein at least one of the first switching signal and the second switching signal is supplied by the electronic device according to at least one of an operation state of the electronic device and/or a charge state of a battery provided in the electronic device.

5. An electronic device comprising a system which has a plurality of electronic components therein, further comprising:
a power supplying apparatus which converts input AC power into DC power; and
a power controller which controls the converting of the input AC power into the DC power by the power supplying apparatus according to the operation of the system, to selectively prevent conversion of the input AC power into the DC power.

6. The electronic device according to claim 5, wherein the power supplying apparatus comprises an AC/DC converter to convert the input AC power into the DC power, and an AC switch to control the AC power input to the AC/DC converter according to a control of the power controller.

7. The electronic device according to claim 6, further comprising a battery to supply power to the system, wherein
the power controller outputs one of a first switching signal and a second switching signal to the power supplying apparatus based on at least one of the operation state of the system and a charge state of the battery by the DC power from the power supplying apparatus, and
the AC switch comprises a first relay part which is magnetized by the AC power to input the AC power to the AC/DC converter; a first switching element which is turned on corresponding to the first switching signal to make the first relay part be magnetized by the AC power; a second relay part which is magnetized by the DC power to cut off the first relay part from being magnetized by the AC power; and a second switching element which is turned on corresponding to the second switching signal to make the second relay part be magnetized by the DC power.

8. The electronic device according to claim 7, wherein the first relay part comprises a first A contact point to make the AC power be input to the AC/DC converter according to a magnetization by the AC power and a second A contact point which is connected with the first switching element in parallel to maintain a magnetization state of the first relay part by the AC power according to the magnetization by the AC power.

9. The electronic device according to claim 7, wherein the power controller outputs the second switching signal to the power supplying apparatus if it detects that the charge of the battery is completed in a state that the system does not operate.

10. The electronic device according to claim 7, wherein the power controller outputs the first switching signal to the power supplying apparatus if it detects an operation of the system or a charge attempt of the battery.

11. The electronic device according to claim 10, further comprising a power button to turn on the electronic device and an auxiliary power source to supply power to the power button, wherein
the first switching signal is output to the power supplying apparatus corresponding to an adjustment of the power button.

12. The electronic device according to claim 9, further comprising a power button to turn on the electronic device and an auxiliary power source to supply power to the power button, wherein
the first switching signal is output to the power supplying apparatus corresponding to an adjustment of the power button.

13. An apparatus to supply DC power to an electronic device, comprising:
a converter to convert AC power into DC power; and
a switch that enables the converter to convert AC power into DC power based on a first signal from the electronic device, and disables the converter to prevent the converter from converting AC power into DC power based on a second signal from the electronic device.

14. The apparatus of claim 13, wherein the switch comprises:
a first relay part that enables the converter to convert AC power into DC power when turned on, and comprising a first switching element to receive the first signal and a first coil connected to the first switching element, wherein the first coil is turned on by the first signal to the first switching element; and
a second relay part that disables the converter from converting AC power into DC power when turned on, and comprising a second switching element to receive the second signal and a second coil connected to the second switching element, wherein the second coil is turned on by the second signal to the second switching element.

15. The apparatus of claim 14, wherein the first relay part includes a contact which is turned off when the second coil of the second relay is turned on.

16. The apparatus of claim 14, wherein the first relay part includes a contact in parallel to the first switching element, wherein the first coil remains magnetized when the contact is turned on.

17. The apparatus of claim 13, wherein the switch comprises:
a first relay part that enables the converter to convert AC power into DC power when turned on, and comprising a first switching element to receive the first signal and a first coil connected to the first switching element, wherein the first coil is turned on by the first signal to the first switching element.

18. The apparatus of claim 13, wherein the switch comprises:
a second relay part that disables the converter to prevent the converter from converting AC power into DC power when turned on, and comprising a second switching element to receive the second signal and a second coil connected to the second switching element, wherein the second coil is turned on by the second signal to the second switching element.

19. The apparatus of claim 13, wherein the electronic device comprises:
a power controller to produce the first and second signals, the power controller comprising:
a microcomputer to produce a battery charge-on signal and/or a battery charge-off signal;
a power button to produce an power-on signal and/or an power-off signal;
an OR gate to produce the first signal based on a logical sum of the charge-on signal and the power-on signal; and
an AND gate to produce the second signal based a logical product of the charge-off signal and the power-off signal.
